(19) United States
(12) Patent Application Publication
(10) Pub. No.: US 2004/0179212 A1
(43) Pub. Date: Sep. 16, 2004

(54) Tape printing apparatus

(75) Inventor: Hiroyasu Kurashina, Natsumoto-shi (JP)

Correspondence Address: HOGAN & HARTSON L.L.P., 500 S. GRAND AVENUE, SUITE 1900, LOS ANGELES, CA, 90071-2611, US

(73) Assignee: SEIKO EPSON CORPORATION

(21) Appl. No.: 10/742,447

(22) Filed: Dec. 19, 2003

(30) Foreign Application Priority Data
Jan. 15, 2003 (JP) 2003-007494

(51) Int. Cl. G06F 15/00

(52) U.S. Cl. 358/1.7; 358/1.15

(57) ABSTRACT

A tape printing apparatus includes: a print unit for printing on a printing tape; a support information storage region which stores in advance multiple pieces of support information about the tape printing apparatus itself and the printing tape; a selection key for selecting any one piece of support information from the multiple pieces of support information stored in the support information storage region; a display screen for displaying the support information; and a control unit. The control unit reads the one piece of support information, which is selected by the selection key, from the support information storage region and causes the read information to be displayed on the display screen.

### BACKGROUND OF THE INVENTION

1. Field of the Invention

The present invention relates to a tape printing apparatus capable of displaying support information about the tape printing apparatus itself and a printing tape.

2. Description of the Related Art

There is known a tape printing apparatus which inputs print data while looking at a display screen and prints the inputted print data on a printing tape.

Support information is required in a case where a trouble arises during an operation of the tape printing apparatus, a case where a user wants to purchase a particular tape cartridge to be fitted in the tape printing apparatus, and the like. In such cases, the user has conventionally obtained necessary information from an instruction manual. However, the user does not always have the instruction manual with him/her during the operation of the tape printing apparatus. Thus, the conventional tape printing apparatus has diminished the convenience for the user when the trouble arises. Moreover, it is also conceivable that the user loses the instruction manual. In such a case, the user cannot obtain the support information he/she needs from the instruction manual. Consequently, it becomes significantly difficult for the user to receive permanent after-sales service.

### SUMMARY OF THE INVENTION

It is an advantage of the present invention to provide a tape printing apparatus capable of displaying and printing support information in accordance with needs of a user and improving the convenience for the user.

The tape printing apparatus according to the present invention comprises: support information storage means for storing in advance multiple pieces of support information about the tape printing apparatus itself and a printing tape; selection means for selecting any one piece of support information from the multiple pieces of support information stored in the support information storage means; display means for displaying the support information; and first control means for reading the one piece of support information, which is selected by the selection means, from the support information storage means and causing the display means to display the read information.

According to this arrangement, the multiple pieces of support information about the tape printing apparatus itself and the printing tape are previously stored in the support information storage means. Thus, any one piece of support information can be selected from the multiple pieces of support information stored in the support information storage means and can be displayed. Therefore, as the support information, information about how to deal with troubles in operations of the tape printing apparatus and about consumable goods (a tape cartridge and the like) are stored in the support information storage means beforehand. Thus, when the user requires the support information in such cases as where the troubles arise in the operations of the tape printing apparatus and where the user wants to purchase the consumable goods, the user can obtain desired support information by displaying the support information on a display screen. For example, when the troubles arise in the operations of the tape printing apparatus, the user can obtain the support information immediately from the tape printing apparatus and deal with the troubles. Moreover, if product information about the tape cartridge is stored beforehand as the support information, the user can purchase a desired tape cartridge by referring to this information.

Preferably, the multiple pieces of support information include at least one or more of telephone numbers and addresses to make inquiries about the tape printing apparatus itself and the printing tape.

According to this arrangement, the support information includes at least one or more of the telephone numbers and addresses to make inquiries about the tape printing apparatus itself and the printing tape, the telephone numbers and addresses being the most frequently used information in the support information. Thus, the convenience for the user can be improved. Particularly, when the user wants to make telephone inquiries about a product, the user can make a phone call while looking at a displayed telephone number, which is convenient.

Preferably, the tape printing apparatus further comprises: print means for printing the support information; and second control means for reading any one piece of support information, which is selected by the selection means, from the support information storage means and causing the print means to print the read information.

According to this arrangement, the one piece of support information, which is selected by the selection means, can be printed. Thus, the convenience for the user can be improved. For example, by printing the support information frequently referred to, it is not required to repeat operations for obtaining the support information. Moreover, when the user wants to apply for purchase of a product or return the product, an address to make inquiries about the product is selected as the support information and is printed. Thus, an address label on which the address to make inquiries is printed is created, which is convenient. Moreover, as the support information about the printing tape, a product number of a desired printing tape and the like are printed beforehand. Thus, without searching through a catalog again, a tape cartridge can be easily ordered.

Preferably, the multiple pieces of support information include support information that cannot be displayed all at once by the display means.

According to this arrangement, when the support information cannot be displayed all at once by the display means, for example, when the display screen is small and only a part of the support information can be displayed, the user can obtain necessary information easily by printing the support information. Thus, the user is not forced to go through cumbersome operations.

Preferably, when a predetermined key operation is performed, the second control means reads a telephone number to make inquiries from the support information storage means and causes the print means to print the telephone number.

According to this arrangement, the telephone number to make inquiries can be printed only by performing the predetermined key operation. Thus, even if the support information cannot be clearly displayed on the display screen, such as a case where a problem arises in the display screen, the user can at least know the telephone number to make inquiries. Therefore, the user can receive support by making telephone inquiries.

Preferably, the tape printing apparatus further comprises test print image storage means for storing in advance a test print image for specifying a cause of printing failure, and the second control means reads the test print image from the test print image storage means by a predetermined key operation and causes the print means to print the test print image.

According to this arrangement, the test print image for specifying a cause of failure of the print means can be printed. Thus, when the printing failure occurs, the user can cause the tape printing apparatus to print the test print image and deal with the problem based on the print result. Moreover, when the user makes inquiries about the printing failure, by reporting the print result of the test print image, the user can efficiently receive support for improving the printing failure. Moreover, by asking the user to send a label with the test print image printed thereon, a manufacturer can utilize this label as a material for analyzing the cause for the failure.

Preferably, the tape printing apparatus further comprises tape width detection means for detecting a width of the printing tape. Each piece of support information includes one or more of detailed data information which are prioritized beforehand for printing. When causing the print means to print the support information, the second control means selects one or more of the detailed data information to be printed from the detailed data information included in the support information, based on the detection result of the tape width detection means and the priorities.

According to this arrangement, in printing the support information, the detailed data information to be printed on the printing tape is selected based on the width of the mounted printing tape and the priorities of the detailed data information included in the support information. Therefore, by setting the priorities of the detailed data information in accordance with how much the user needs the information or how often the user utilizes the information, the information can be printed on the printing tape sequentially from the necessary one. Thus, the convenience for the user can be improved. Specifically, when the width of the printing tape is narrow and it is difficult to print all the information, only the detailed data information with higher priority (need) is printed. Thus, it is possible to efficiently provide the user with the support information.

Preferably, the tape printing apparatus further comprises a printer case which forms an external shape of the tape printing apparatus itself and has an attachment region capable of attaching the printed tape therein and that the second control means sets a print region where the print means prints the support information so as to fit in the attachment region.

According to this arrangement, the print region where the print means prints the support information is set to fit in the attachment region of the printer case. Thus, the printing tape having the support information printed thereon can be properly attached to the printer case. Therefore, the user can print the frequently used support information, such as the telephone number to make inquiries, on the printing tape and can attach this tape to the printer case. Consequently, the user can always refer to the support information and the convenience for the user can be improved.

Preferably, the tape printing apparatus further comprises annunciation means for announcing an error when the width of the mounted printing tape is wider than that of the print region.

According to this arrangement, in the case where the support information is printed on the printing tape for the purpose of attaching the tape to the printer case, an error is displayed when the width of the mounted printing tape is wider than that of the print region. Thus, the user can be informed that the width of the printing tape is wider than that of the attachment region of the printer case.

Preferably, when the width of the mounted printing tape is wider than that of the print region, the second control means causes the print means to print an indicator of the width of the print region together with the support information.

According to this arrangement, when the width of the printing tape is wider than that of the attachment region of the printer case, the indicator of the width of the print region is printed together with the support information. Thus, by cutting up the printing tape by using this indicator as a guide, the user can easily create a label which fits in the attachment region of the printer case.

In these cases, preferably, the tape printing apparatus further comprises information update means for updating the support information stored in the support information storage means.

According to this arrangement, the support information can be updated and stored in the support information storage means. Thus, even if the support information is changed, such as a case where the telephone number to make inquiries is changed, it is possible to provide the user with appropriate support information by updating the support information. The update of the support information is performed in such a manner that the tape printing apparatus is connected to an external device such as a personal computer, new support information are downloaded from the external device by using a data communication function and the like, and existing data are replaced with the new data.

### BRIEF DESCRIPTION OF THE DRAWINGS

The above and other advantages and the attendant features of this invention will become readily apparent by reference to the following detailed description when considered in conjunction with the accompanying drawings wherein:

FIG. 1 is an external perspective view of a tape printing apparatus according to one embodiment of the present invention;

FIG. 2 is an external perspective view of the tape printing apparatus when its opening and closing cover is opened and a tape cartridge fitted in the tape printing apparatus;

FIG. 3 is a block diagram of a control system of the tape printing apparatus according to the one embodiment of the present invention;

FIG. 4 is a flowchart schematically showing processing of the entire control of the tape printing apparatus according to the one embodiment of the present invention;

FIG. 5 is a view showing display screens and a flow of operations when a support information display menu is displayed;

FIG. 6 is a view showing a list of the support information display menu in the tape printing apparatus according to the one embodiment of the present invention;

FIG. 7 is a view showing display screens and a flow of operations until support information corresponding to “product purchase” in the support information display menu is displayed;

FIG. 8 is a view showing display screens and a flow of operations until support information corresponding to “printing failure” in the support information display menu is displayed;

FIG. 9 is a view showing display screens and a flow of operations when “tape cartridge guidance” in the support information display menu is selected; and

FIG. 10A is a view showing display screens and a flow of operations when a label to be attached in a label attachment region of the opening and closing cover is created and FIG. 10B is a view showing labels for the label attachment region of the opening and closing cover, which are created by using printing tapes having different widths from each other.

### DETAILED DESCRIPTION OF THE PREFERRED EMBODIMENTS

A tape printing apparatus according to one embodiment of the present invention will be described below in detail with reference to the accompanying drawings.

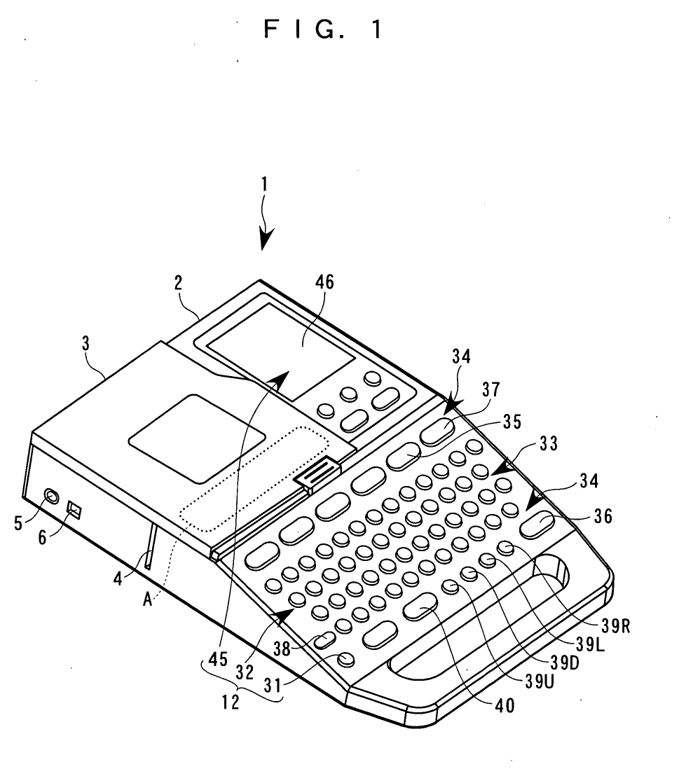

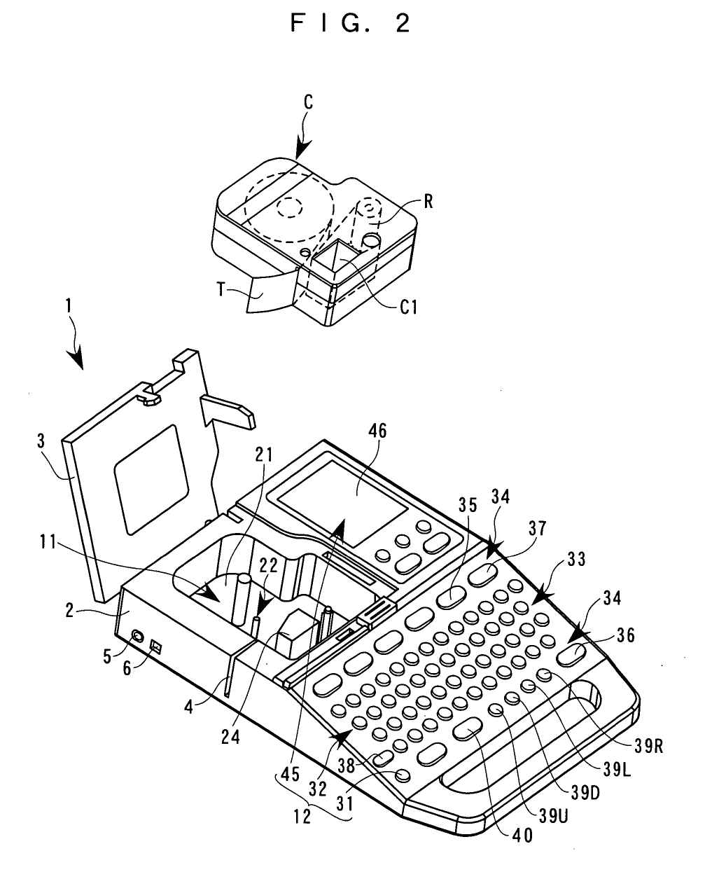

FIG. 1 is an external perspective view of the whole tape printing apparatus according to the embodiment. FIG. 2 is an external perspective view of the tape printing apparatus having its opening and closing cover opened and a tape cartridge. As shown in the both drawings, the tape printing apparatus 1 is entirely covered with a cover case 2 and, in an upper left portion at the rear of the cover case 2, a pocket 21 for fitting the tape cartridge C therein and its opening and closing cover 3 are provided. Moreover, a display 45 is provided to the right of the opening and closing cover 3 and a keyboard 32 is provided in an upper front portion of the tape printing apparatus 1. Moreover, in a left side portion of the cover case 2, a tape ejection opening 4 for ejecting a printed printing tape T, a power source connection port 5 for inserting a power source adapter and an external device connection port 6 (information update means) for connecting the tape printing apparatus 1 with an external device are provided.

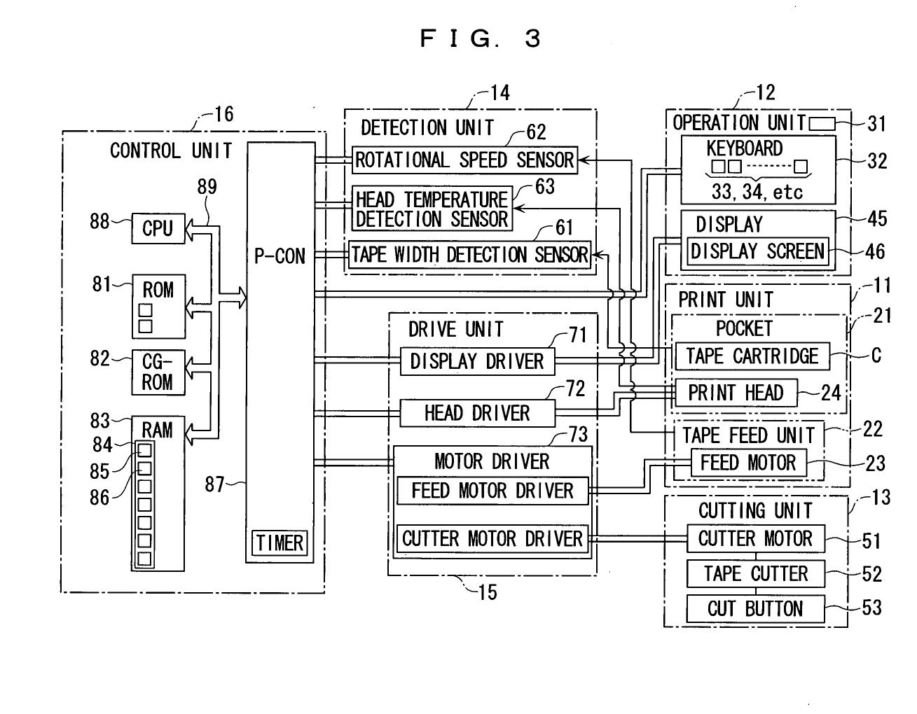

Moreover, as shown in FIG. 3, as its basic configuration, the tape printing apparatus 1 includes: a print unit 11 (print means) which is provided in the pocket 21 and includes a print head 24 to be described later for printing; an operation unit 12 which includes the keyboard 32 and the display 45 and serves as an interface between the tape printing apparatus and a user; a cutting unit 13 which includes a tape cutter 52 and cuts the printed printing tape T; a detection unit 14 which includes various sensors for performing various detections; a drive unit 15 for driving the respective units via various drivers; and a control unit 16 (control means) for controlling the respective units of the tape printing apparatus 1.

This tape printing apparatus 1 creates a label in the following manner. Specifically, based on print information inputted from the keyboard 32, the print unit 11 prints print data composed of characters, such as letters, numbers and symbols, on the printing tape T while letting out the printing tape T of the tape cartridge C. At the same time, a printed part of the tape is ejected from the tape ejection opening 4 and the printing tape T is cut at a predetermined position by the tape cutter 52 provided at the tape ejection opening 4. Thus, the label is created. The respective units of the tape printing apparatus 1 are controlled by the control unit 16 via the various drivers of the drive unit 15 to be described later. The control unit 16 controls the entire tape printing apparatus 1 as well as the respective units individually.

The tape cartridge C used in this tape printing apparatus 1 houses the printing tape T and an ink ribbon R therein, as shown in FIG. 2. Various types of tape cartridges are prepared in accordance with a width of the housed printing tape T and the like. In the tape cartridge C, a through-hole C1 is provided, into which the print head 24 is freely inserted when the tape cartridge C is fitted in the pocket 21. On the back of the tape cartridge C, a plurality of identification holes (not illustrated) are provided for identifying the width of the housed printing tape T.

The printing tape T has an adhesive face which is formed on the back thereof and covered with release coated paper. Thus, the printing tape T can be attached as a label after being printed. As to the printing tape T, several types of tapes having different widths from each other as well as tapes in various colors and of various materials are prepared.

Next, constitutions of the respective units of the tape printing apparatus 1 will be described. As shown in FIGS. 2 and 3, the printer unit 11 includes: the pocket 21 for fitting the tape cartridge C therein; a tape feed unit 22 for feeding the printing tape T by using a feed motor 23 as a driving source while letting out the tape from the tape cartridge C fitted in the pocket 21; and the print head 24 including a thermal head covered with a head cover. The print unit 11 performs printing while feeding the printing tape T of the tape cartridge C fitted in the pocket 21. When the print head 24 is heated and driven, characters such as letters are printed on the printing tape T and, in synchronization with this printing, the tape feed unit 22 accordingly feeds the printing tape T.

In the pocket 21, there are provided: a tape width detection sensor 61 (tape width detection means) for detecting the width of the printing tape T of the tape cartridge C fitted in the pocket 21; a head temperature detection sensor 63 for detecting a surface temperature of the print head 24; and a rotational speed sensor 62 for detecting a rotational speed of the feed motor 23. The tape width detection sensor 61 has a plurality of microswitches (not illustrated) and detects the width of the printing tape T by detecting arrangement (a bit pattern) of the above-described identification holes of the tape cartridge C.

The operation unit 12 includes: a power source button 31 for turning on power; the keyboard 32 having various keys; and the display 45 having a display screen 46 for displaying the print information including the print data. In the keyboard 32, arranged are: a character key group 33 having an alphabet key group, a symbol key group and the like; a function key group 34 for specifying various operations; and the like.

In the function key group 34, provided are: a print key 35 for instructing a print operation; a selection key 36 for selecting and instructing various modes in a selection screen, such as determination of data and line feed in inputting the print data; a cancel key 37 for canceling various instructions; a shift key 38 used for changing roles of respective keys and the like; a conversion key 40 for converting inputted hiragana into kanji; four cursor keys 39 (39U, 39D, 39R and 39L) for moving a cursor or a display range of the display screen 46; and the like.

The display 45 includes: the display screen 46 (display means) capable of displaying display image data of 32 dots×64 dots; and eighteen indicators (annunciation means: not shown) for displaying various setting situations. The display 45 is used for viewing and editing the print data inputted by using the keyboard 32.

The cutting unit 13 includes: the tape cutter 52 provided at the tape ejection opening 4; a cutter motor 51 for automatically causing the tape cutter 52 to perform a cutting operation; and a cut button 53 for manually causing the tape cutter 52 to perform the cutting operation. The cutting unit 13 can switch between automatic/manual modes of tape cutting by setting a tape cutting mode (see FIG. 3).

The detection unit 14 includes various sensors including the tape width detection sensor 61, the rotational speed sensor 62 and the head temperature detection sensor 63, which are described above. The detection unit 14 sends detection signals from the various sensors to the control unit 16 and enables the control unit 16 to control the respective parts based on these signals. The above-described sensors may be provided according to actual situations.

The drive unit 15 drives the respective parts based on control signals outputted from the control unit 16. The drive unit 15 includes: a display driver 71 which drives the display 45; a head driver 72 which drives the print head 24; a motor driver 73 which drives respective motors in the tape printing apparatus 1; and the like.

As shown in FIG. 3, the control unit 16 includes: a ROM 81 which stores control programs and control data; a character generation ROM (CG-ROM) 82 which stores font data such as letters, symbols and graphics and, upon receipt of code data such as letters, outputs font data corresponding to the code data; a RAM 83 which includes a register group (not illustrated) storing various data and a storage region 84 and is used as a work area for control processing; a peripheral control circuit (P-CON) 87 which supplements functions of a CPU 88 and handles interface signals between the P-CON 87 and peripheral circuits; the CPU 88 which processes (reads) various data in the CG-ROM 82 and the RAM 83 in accordance with the control programs stored in the ROM 81 and outputs, via the P-CON 87, control signals for controlling driving of the respective parts of the tape printing apparatus 1. The above-described parts are connected with each other by an internal bus 89. The control unit 16 is connected with the respective parts of the tape printing apparatus 1 and controls the entire tape printing apparatus 1. The control unit 16 performs, for example, setting of the print region under predetermined print conditions, feeding of the tape under predetermined conditions and the like. Specifically, the control unit 16 doubles as first and second control means described in claims.

As described later, the storage region 84 of the RAM 83 includes: a support information storage region 85 (support information storage means) for storing support information; a test print image storage region 86 (test print image storage means) for storing test print image data for printing a test print image to specify a cause of printing failure; a storage region for storing a manufacturing date of the tape printing apparatus 1 main body and a serial number thereof; a storage region for counting the number of times of pressing the print key 35 and storing the counted number; and the like.

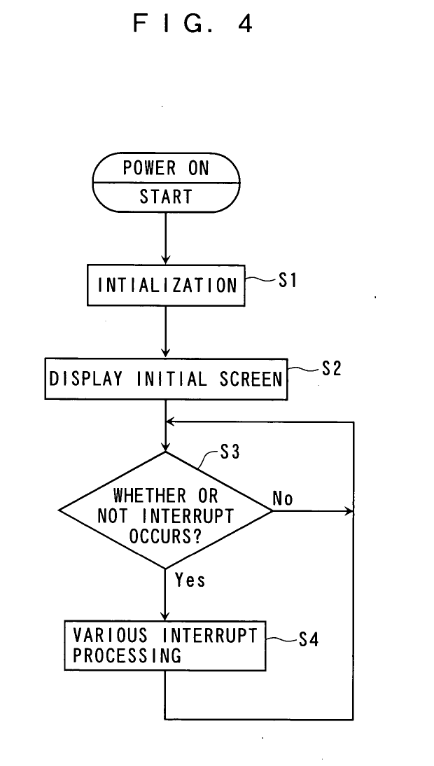

Next, with reference to FIG. 4, description will be given of a processing flow of the entire control of the tape printing apparatus 1. First, when processing is started by turning on power and the like, initialization is performed for bringing the tape printing apparatus 1 back to a requested initial state (S1). Next, an initial screen is displayed on the display screen (S2). When the initial screen display is finished and a key input interrupt is permitted, the tape printing apparatus 1 becomes a key input interrupt stand-by state (S3: No) and key input is made possible. When the key input interrupt is made by the key input (S3: Yes), the processing moves to interrupt processing (S4). After the interrupt processing is finished, the tape printing apparatus 1 becomes the key input interrupt stand-by state again (S3: No). The determination of whether or not the key input is made (S3) and various interrupt processing (S4) are described on a conceptual basis.

As described above, in the tape printing apparatus 1, the processing is mainly performed by the interrupt processing. Thus, if the tape printing apparatus 1 is ready for print image creation and printing, the user presses the print key 35 at a given point in time to make a print processing interrupt and start the print processing for printing. Consequently, the user can optionally select the operating procedure up to printing.

Based on the above-described point, main parts of the present invention will be described. As described above, in the tape printing apparatus 1 according to the embodiment, the support information storage region 85 is included in the storage region 84 of the RAM 83 and a plurality of pieces of support information about the tape cartridge C (the printing tape T) are previously stored in the tape printing apparatus 1 itself. Thus, according to needs of the user, the control unit 16 can read the support information from the support information storage region 85 of the RAM 83, cause the support information to be displayed on the display screen 46 of the display 45 and cause the support information to be printed on the printing tape T. Therefore, when a trouble occurs during the operation of the tape printing apparatus 1 or when the user wants to purchase a (particular) tape cartridge C which fits the user's intended use, even if the user does not have an instruction manual of the tape printing apparatus 1 with him/her, the support information can be called up from the support information storage region 85 and easily referred to.

Each piece of the support information stored in the support information storage region 85 includes at least one or more of detailed data information to be contents of the support information. To the respective pieces of detailed data information, priorities in printing on the printing tape T are attached (details thereof will be described later). Moreover, the respective pieces of support information stored in the support information storage region 85 correspond to menu items of a support information display menu. Accordingly, when the user selects one of the menu items from the support information display menu on the display screen 46, support information corresponding to the selected item is called up from the support information storage region 85. Thereafter, detailed data information included in the support information is displayed on the display screen 46 in the order of descending priorities.

The support information (the detailed data information) stored in the support information storage region 85 can be updated to new support information by connecting the tape printing apparatus 1 to the external device such as a personal computer. For example, the tape printing apparatus 1 is connected to the external device via the external device connection port 6 and the external device accesses a website for downloading new support information. Thereafter, the new support information is stored in the support information storage region 85 via the external device. Moreover, the support information stored in the support information storage region 85 is different from usual text data and cannot be edited (changed) on the display screen 46.

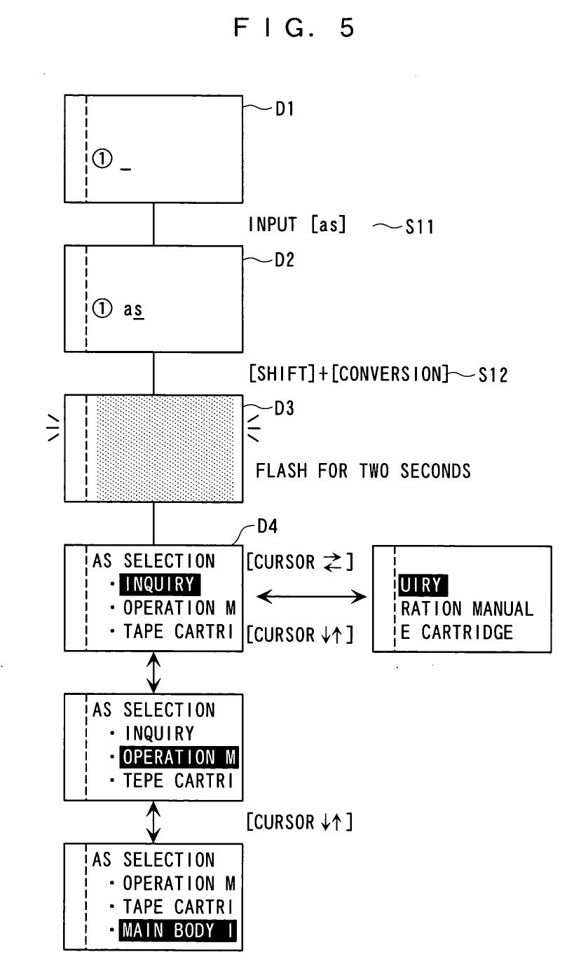

Next, the support information display menu will be described. As shown in FIG. 5, in a state where no letter or the like is inputted in a text input screen (D1), that is, in an initial screen of the text input screen, [as] is inputted in lower-case letters (S1:D2). Thereafter, as the shift key 38 and the conversion key 40 are simultaneously pressed (S12), after the display screen 46 flashes for two seconds (D3), the support information display menu is displayed on the display screen 46 (D4). The support information display menu may be displayed on the display screen 46 by providing a dedicated key to display the support information display menu and pressing this dedicated key.

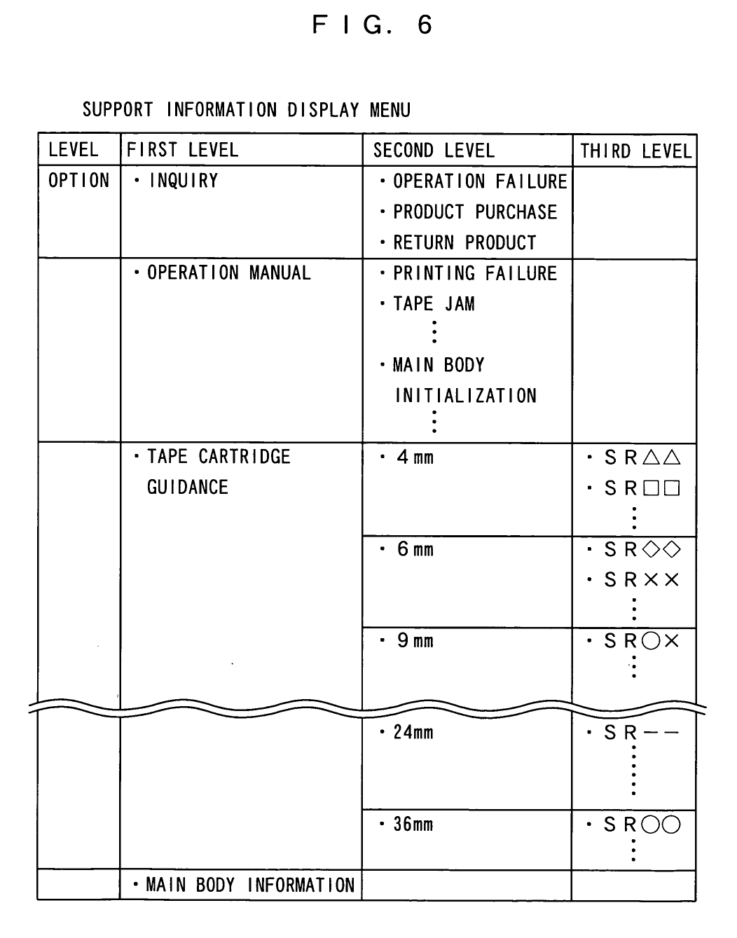

As shown in FIGS. 5 and 6, in the support information display menu, as options (of a first level or hierarchy), “inquiry,” “operation manual,” “tape cartridge guidance” and “main body information” are prepared. Selection from the options (the menu items) of the menu is performed by using the cursor keys 39 and the selection key 36 in the above-described function key group 34. Moreover, the display screen 46 of the embodiment is small and the support information cannot be displayed all at once. Thus, displayed contents are moved (scrolled) from side to side and up and down by operating the cursor keys 39 (see FIG. 5 and the like).

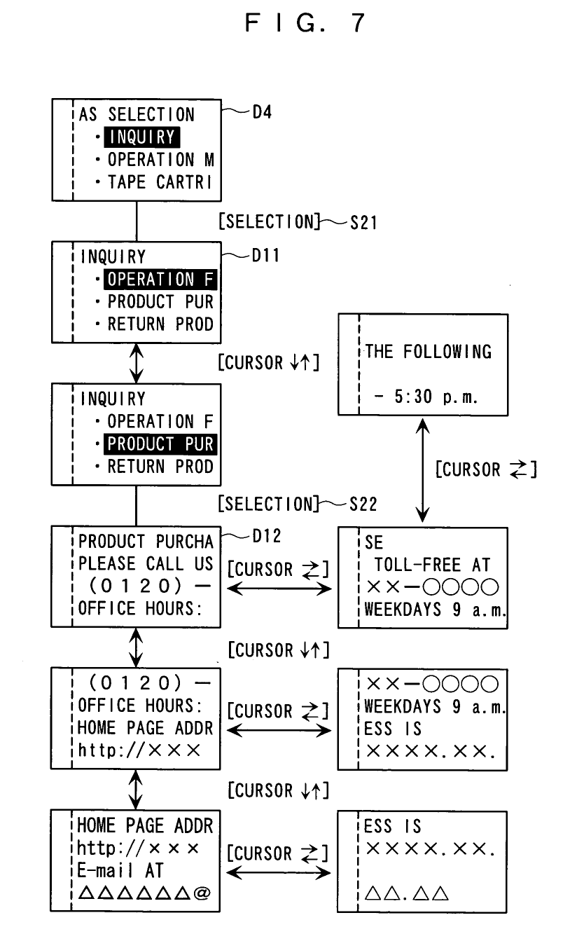

The menu item “inquiry” displays information for the user to make inquiries about products, namely, the tape printing apparatus and the tape cartridge. As shown in FIG. 7, when “inquiry” is selected from the support information display menu (S21), “operation failure,” “product purchase” and “return product” are displayed as options of a second level (D11). By selecting the menu item having contents to make inquiries about at the second level, the support information is displayed.

When the menu item “operation failure” or “product purchase” is selected at the second level (S22), detailed data information included in support information corresponding to “operation failure” or “product purchase” are displayed on the display screen 46 (D12). The support information corresponding to “operation failure” or “product purchase” includes four pieces of detailed data information, which are: a telephone number of a place (a support center) to make inquiries (about operation failure of the tape printing apparatus or purchase of the tape printing apparatus and the tape cartridge); office hours for inquiries; a homepage address (URL) of the support center; and an e-mail address of the support center. Priorities of these four pieces of detailed data information are as follows: telephone number>office hours>homepage address>e-mail address. The four pieces of detailed data information are displayed on the display screen 46 in the order of descending priorities (see FIG. 7).

Meanwhile, support information corresponding to the menu item “return product” includes three pieces of detailed data information, which are: a telephone number of a place to make inquiries when returning a product; an address of a place to return the product to; and a bar code corresponding to the address of the place to return the product to. When the menu item “return product” is selected at the second level, these three pieces of detailed data information are displayed in the order of descending priorities: telephone number>address>bar code.

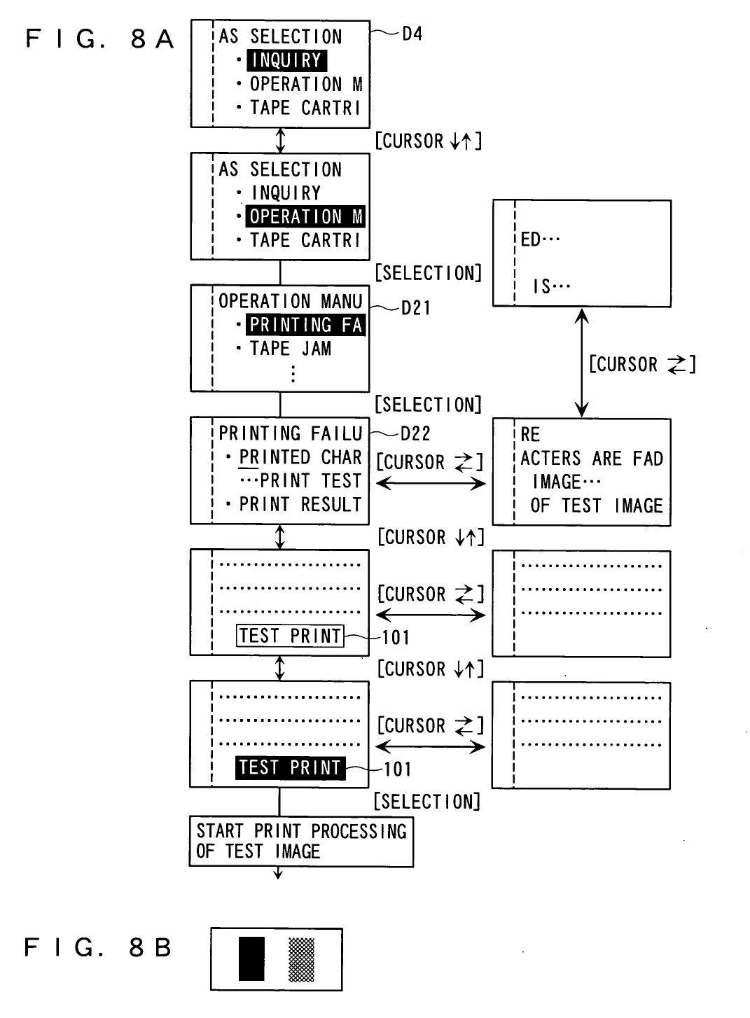

The menu item “operation manual” displays information for dealing with troubles that arise during the operation of the tape printing apparatus 1. As shown in FIG. 8, as options of “operation manual” at the second level, common troubles in the tape printing apparatus 1, such as “printing failure” and “tape jam,” are enumerated (D21). The support information corresponding to the trouble selected at the second level is displayed on the display screen 46 (D22). The support information of “operation manual” includes detailed data information indicating ways of dealing with troubles.

The support information of “printing failure” includes ways of dealing with troubles based on a print result of a test print image. When “printing failure” is selected, in addition to the support information, a test print image print button 101 for printing a test print image by ON/OFF switching is displayed (see FIG. 8A). The test print image means a predetermined image printed by the print head 24 in order to specify a cause of printing failure. When the cursor keys 39 are operated and the selection key 36 is pressed in a state where the test print image print button 101 is ON, the control unit 16 reads test print image data from the above-described test print image storage region 86 of the RAM 83 and causes the print unit 11 to print a test print image. FIG. 8B is a view showing a label obtained by printing the test print image on the printing tape.

Moreover, as options of “operation manual” at the second level, besides the options of displaying the ways of dealing with common troubles of the tape printing apparatus 1, options of displaying operating procedures which may be frequently referred to by the user, such as “main body initialization” which displays procedures to initialize setting of the tape printing apparatus 1, are prepared (see FIG. 6).

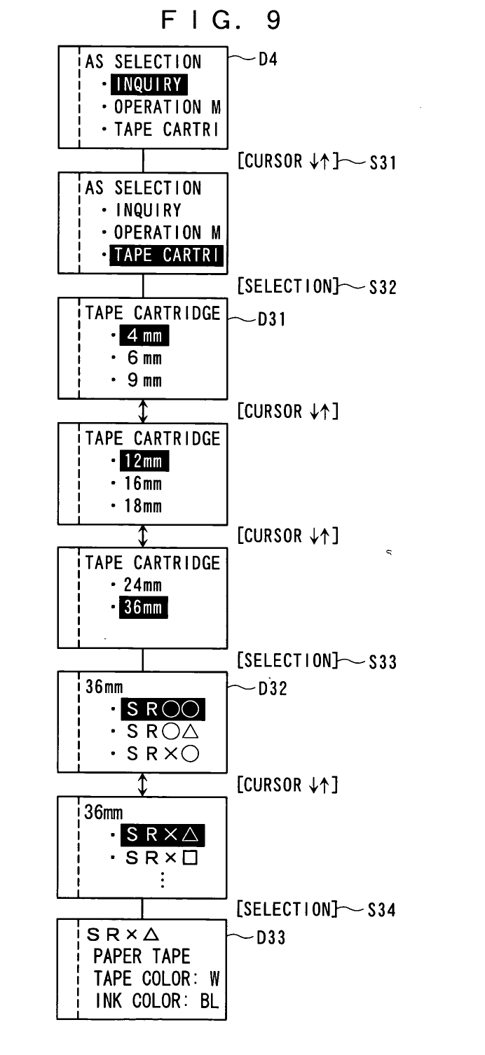

The menu item “tape cartridge guidance” introduces a plurality of tape cartridges C prepared according to the width of the printing tape T. As shown in FIG. 9, when the cursor keys 39 are operated (S31) and “tape cartridge guidance” is selected (S32), as the options of the second level, widths of the prepared printing tapes T are displayed (D31). Thereafter, when the user selects the width of the desired printing tape T (S33), as options of a third level, part numbers of tape cartridges C having the printing tape T with the selected tape width are displayed (D32). Subsequently, when the user selects the part number of the tape cartridge C (S34), in addition to the selected part number of the tape cartridge C, a name of the printing tape T, a color of the printing tape T and a color of the ink cartridge R (letters or images to be printed) are displayed (D33). Specifically, by selecting the width of the desired printing tape T, the user can search for the tape cartridge C corresponding to the printing tape T.

The menu item “main body information” displays basic information about the tape printing apparatus 1 main body. When “main body information” is selected, data is read from the storage region of the RAM 83 and the manufacturing date of the tape printing apparatus 1, the serial number thereof, the number of times of pressing the print key 35 and the like are displayed on the display screen 46 (see FIG. 6).

In the meantime, on the cover case 2 of the tape printing apparatus 1 according to the embodiment, the tape ejection opening 4, a battery cover (not illustrated) for a battery mounted in the tape printing apparatus 1 and a label attachment region A are provided. Specifically, the label attachment region A is provided around letters and the like which are previously printed on the cover case 2. Thus, a label (which has the support information printed thereon) can be attached to the cover case 2. The label attachment region A of the cover case 2 is provided on the opening and closing cover 3, the right side portion of the tape printing apparatus 1 or the bottom portion of the tape printing apparatus 1. A size of the label attachment region A is as follows. The opening and closing cover: height 1.6 cm×width 7 cm, the side portion: height 2.5 cm×width 10 cm and the bottom portion: height 6 cm×width 6 cm. The setting position and size of the label attachment region A can be optionally set according to actual situations.

The tape printing apparatus 1 is relatively small and the label attachment region A is limited. Thus, in the tape printing apparatus 1 according to the embodiment, the print region for printing the support information and the detailed data information are set so as to fit in the label attachment region A. Accordingly, a label which fits in the label attachment region A can be created. When creating a label attached in the label attachment region A, the user is allowed to select a position for attaching the label and the label attachment region A as the attaching position and the print region corresponding to the width of the printing tape T (of the mounted tape cartridge C) are set. At the same time, based on the size of the set print region, detailed data information to be printed is selected.

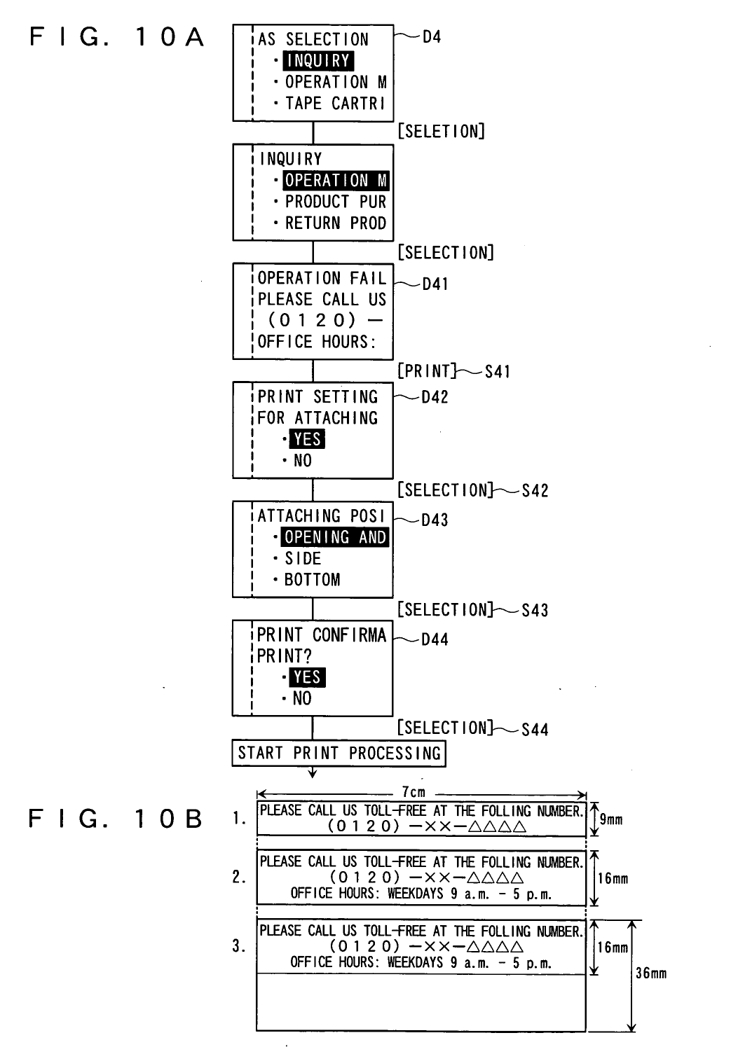

With reference to FIG. 10A, concrete description will be given of a method for creating a label attached to the label attachment region A. In the embodiment, when the print key 35 is pressed in a state where the support information is displayed on the display screen 46 (D41), the tape printing apparatus is switched to a support information print mode. If the print key 35 is pressed when the support information is displayed on the display screen 46 (S41), the tape printing apparatus is switched to the support information print mode and a print setting screen is displayed (D42). In the print setting screen, to a question of “for attaching to main body?,” “Yes” or “No” can be selected. In the case of creating a label to be attached to the cover case 2, “Yes” is selected (S42). When “Yes” is selected, next, an attaching position selection screen is displayed (D43) and an attaching position of the label is selected from “opening and closing cover,” “side portion” and “bottom portion.” Thereafter, when the attaching position of the label is selected (S43), a print confirmation screen is subsequently displayed (D44). If “Yes” is selected here (S44), print processing is started to create a label for the label attachment region A of the opening and closing cover 3.

If the width of the mounted printing tape T is larger than a vertical width of the label attachment region A at the selected attaching position of the label, an error is announced by an indicator (not illustrated) of the display 45 and an error announcing tone. At the same time, a confirmation screen for confirming whether or not the print processing is carried on is displayed on the display screen 46. Here, if it is selected that the print processing is continuously carried on, the print region is set in accordance with the vertical width of the label attachment region.

Once the print processing is started, first, the control unit 16 sets the print region of the support information to be printed based on the detection result of the width of the printing tape T, which is obtained by the above-described tape width detection sensor 61, and the size of the label attachment region A of the selected attaching position. For example, if the attaching position is “opening and closing cover,” the print region of the label is automatically set as follows. Specifically, when the width of the printing tape T is 1.2 cm, the print region of the label is set to height 1.2 cm×width 7 cm in accordance with the vertical width of the printing tape T, and when the width of the printing tape T is 2.4 cm, the print region of the label is set to height 1.6 cm×width 7 cm in accordance with the vertical width of the label attachment region A. Along with the setting of the print region, a size of printed characters, a character gap and the like are also automatically set.

Once the print region is set, next, the control unit 16 sets print contents. As described above, the respective pieces of detailed data information included in the support information are prioritized. Accordingly, the control unit 16 selects the detailed data information to be printed in the order of descending priorities while taking into consideration the number of characters (information amount) in each piece of detailed data information so as to print the information in the print region defined by the set size of printed characters and the set character gap. Specifically, even if a horizontal width of the print region stays the same, the shorter the vertical width of the print region (the width of the printing tape T) is, the smaller the number of lines of character strings (the number of characters) which can be printed becomes. Thus, as the vertical width of the print region is shortened, it is set to print only the higher priority detailed data information.

Moreover, in this event, when the width of the mounted printing tape T is larger than the width of the set print region, it is set to print an indicator of the print region together with the detailed data information. This indicator can be used as a guide when the user cuts a created label in accordance with the width of the label attachment region A. Even if it is set to print only the highest priority detailed data information, when the printed information does not fit in the set print region, an error is announced by an indicator (not illustrated) and an error announcing tone.

When the selections of the print region and the detailed data information to be printed by the control unit 16 are finished, the print unit 11 is driven to print the selected detailed data information in the set print region.

If “No” is selected in the above-described print setting screen (D42), a print range setting screen is displayed and full-text printing of the support information or partial printing thereof can be selected. In the full-text printing, all the support information displayed on the display screen 46 is printed. In the partial printing, only the support information of which range is specified by using the cursor keys 39 is printed. Here, in accordance with the support information to be printed, the print region is set. Specifically, the more the contents of the printed support information are increased, the larger the print region becomes.

FIG. 10B shows examples of labels to be attached in the label attachment region A of the opening and closing cover, the labels being created by using printing tapes T having different widths from each other. On each of the created labels, the support information corresponding to the menu item “operation failure” of “inquiry” is printed. As shown in FIG. 10B, a horizontal width (length) of the label is set in accordance with the horizontal width (7 cm) of the label attachment region A in all the printing tapes T. A vertical width of the label is set to the width of the printing tape T when the vertical width of the label attachment region A>the width of the printing tape T (see FIG. 10B, 1). On the other hand, the vertical width of the label is set to the vertical width of the label attachment region A when the vertical width of the label attachment region A≦the width of the printing tape T (see FIG. 10B, 2 and 3). Meanwhile, when the label attachment region A<the width of the printing tape T, an indicator of the vertical width of the print region, that is, the label attachment region is printed together with the support information (see FIG. 10B, 3).

As described above, in the tape printing apparatus 1 according to the embodiment, the support information stored in the support information storage region 85 of the RAM 83 can be displayed on the display screen 46 and the displayed support information can be printed.

Moreover, in the tape printing apparatus 1 according to the embodiment, when the print key 35 is pressed in a state where “a” key and “s” key are simultaneously pressed, a telephone number and office hours to make inquiries, which are included in the support information corresponding to the menu item “operation failure,” are read from the support information storage region 85 of the RAM 83. Thereafter, the telephone number and the office hours are printed on the printing tape T. Specifically, it is made possible to read and print the support information only by a predetermined key operation without operating on the display screen 46. Thus, even if the display screen 46 is not clear, predetermined support information can be obtained from the tape printing apparatus 1.

In the embodiment, the support information is printed by pressing the print key 35 in the state where “a” key and “s” key are simultaneously pressed. However, the above-described operation may be replaced by other key operations such as combining other keys and providing a dedicated key. Moreover, the support information to be printed is not limited to the one described above but can be optionally set.

As described above, the support information is previously stored in the tape printing apparatus according to the present invention and the support information can be displayed on the display screen of the tape printing apparatus. Thus, according to needs of the user, the support information can be referred to from the tape printing apparatus. Therefore, the user does not have to have the instruction manual with him/her all the time to obtain the support information. Moreover, even if the user loses the instruction manual, the user still can obtain the support information. Thus, the convenience for the user can be improved.

Moreover, the tape printing apparatus is configured to be capable of printing the stored support information. Thus, even if the support information is not clearly displayed on the display screen or even if the display screen is small and the support information is not displayed thereon all at once, the support. information can be easily referred to. Furthermore, the print region of the support information is set in accordance with the label attachment region of the cover case. Thus, the label to be attached to the cover case can be easily created.

What is claimed is:

1. A tape printing apparatus comprising:
support information storage means for storing in advance multiple pieces of support information about the tape printing apparatus itself and a printing tape;
selection means for selecting any one piece of support information from the multiple pieces of support information stored in the support information storage means;
display means for displaying the support information; and
first control means for reading the one piece of support information, which is selected by the selection means, from the support information storage means and causing the display means to display the read information.

2. The tape printing apparatus according to claim 1, wherein the multiple pieces of support information include at least one or more of telephone numbers and addresses to make inquiries about the tape printing apparatus itself and the printing tape.

3. The tape printing apparatus according to claim 1, further comprising:
print means for printing the support information; and
second control means for reading any one piece of support information, which is selected by the selection means, from the support information storage means and causing the print means to print the read information.

4. The tape printing apparatus according to claim 3, wherein the multiple pieces of support information include support information that cannot be displayed all at once by the display means.

5. The tape printing apparatus according to claim 3, wherein, when a predetermined key operation is performed, the second control means reads the telephone number to make inquiries from the support information storage means and causes the print means to print the telephone number.

6. The tape printing apparatus according to claim 3, further comprising:
test print image storage means for storing in advance a test print image for specifying a cause of printing failure,
wherein the second control means reads the test print image from the test print image storage means by a predetermined key operation and causes the print means to print the test print image.

7. The tape printing apparatus according to claim 3, further comprising:
tape width detection means for detecting a width of the printing tape,
wherein each piece of the support information includes one or more of detailed data information which are prioritized beforehand for printing and, when causing the print means to print the support information, the second control means selects one or more of detailed data information to be printed from the detailed data information included in the support information, based on a detection result of the tape width detection means and the priorities.

8. The tape printing apparatus according to claim 7, further comprising:
a printer case which forms an external shape of the tape printing apparatus itself and has an attachment region capable of attaching the printed tape therein,
wherein the second control means sets a print region where the print means prints the support information so as to fit in the attachment region.

9. The tape printing apparatus according to claim 8, further comprising:
annunciation means for announcing an error when the width of the mounted printing tape is wider than that of the print region.

10. The tape printing apparatus according to claim 8, wherein, when the width of the mounted printing tape is wider than that of the print region, the second control means causes the print means to print an indicator of the width of the print region together with the support information.

11. The tape printing apparatus according to claim 1, further comprising information update means for updating the support information stored in the support information storage means.
